(19) United States
(12) Patent Application Publication
(10) Pub. No.: US 2008/0283622 A1
(43) Pub. Date: Nov. 20, 2008

(54) METHOD FOR THE TRANSPORT OF HEAT ENERGY AND APPARATUS FOR THE CARRYING OUT OF SUCH A METHOD

(76) Inventor: Dieter Weiss, Walldurn (DE)

Correspondence Address: GIFFORD, KRASS, SPRINKLE,ANDERSON & CITKOWSKI, P.C, PO BOX 7021, TROY, MI, 48007-7021, US

(21) Appl. No.: 12/117,214

(22) Filed: May 8, 2008

(30) Foreign Application Priority Data
May 16, 2007 (DE) 10 2007 022 950.1

(51) Int. Cl. B60H 1/02; F28D 15/00; F02C 6/04

(52) U.S. Cl. 237/12.1; 165/104.25; 60/784

(57) ABSTRACT

The invention relates to a method for the transport of heat energy from at least one heat source to at least one heat sink, in particular for a district heating network, by means of a working fluid which includes a mixture of at least one first component having a first boiling point and of a second component having a second boiling point, with the first boiling point being lower than the second boiling point. The method includes the step of an at least partial vaporization of the first component of the working fluid by the supply of heat from the heat source. The vaporized portion of the first component is transported separately from the working fluid depleted by the vaporization with respect to the first component from the heat source to the heat sink by means of a transport means. Subsequently, the vaporized first component is absorbed by the depleted working fluid while emitting the heat absorbed on the vaporization to the heat sink. The temperature of the first component and of the depleted working fluid on the transport from the heat source to the heat sink substantially corresponds to a temperature prevailing in the environment of the transport means. The invention further relates to an extraction apparatus to increase the efficiency of the extraction of a component of the working fluid and to a district heating network for the transport of heat energy.

### RELATED APPLICATION

This application claims priority of German Patent Application No. 10 2007 022 950.1 filed May 16, 2007.

The present invention relates to a method for the transport of heat energy from at least one heat source to at least one heat sink, in particular for a district heating network. The invention further relates to a corresponding district heating network to increase the efficiency of the extraction of a component of a multicomponent working fluid.

In times of rising raw material prices, the importance of efficient use of the available resources increases. The minimization of losses in the transport of energy from the energy producer to the consumer plays a large role in this connection.

For example, large amounts of waste heat arise in the generation of electricity in thermal power stations which are frequently discharged unused via flowing water or cooling towers. This results, in the one hand, in the heating of the water used for the cooling and/or in fog formation in the vicinity of the cooling towers; on the other hand, the unused discharge of the waste heat has a negative effect on the efficiency of the power station. In other words, a large proportion of the primary energy used is wasted.

An improved utilization of the primary energy is achieved by a so-called power-heat coupling. A power station having power-heat coupling primarily utilizes the energy contained in the fuel used for the generation of steam which is used to drive turbines to generate electrical energy. The steam cooled and expanded after the generation of electricity is then, however, not supplied to a cooling system, but rather utilized for the heating of a secondary water circuit which is in communication with different heat consumers, for example households and/or commercial enterprises, via pipe networks—so called district heating networks. The waste heat of the power station is thus utilized for the direct supply of heat to households and/or industrial enterprises located in the surroundings of the power station.

One of the limiting factors of the described concept is the limited efficiency of the heat transport between the power station and the consumers. Since power stations are usually not built in the direct vicinity of areas of high population density, the heat carrier—that is the hot water of the secondary circuit—must be transported over relatively large distances, with substantial heat losses not being able to be prevented even with a good insulation of the pipes. The efficiency of the power-heat coupling therefore drops, the further the heat has to be transported. Many power stations are thus not linked to the district heating networks due to their large distance to suitable consumers.

It is the underlying object of the invention to provide a reliable method for the transport of heat energy which has reduced heat losses during transport and is simultaneously commercially competitive. Furthermore, an apparatus for the efficient implementation of the method and a district heating network suitable for the transport method should be provided.

This object is satisfied by a method for the transport of heat energy having the features of claim 1 as well as by an extraction apparatus and a district heating network having the features of claims 11 and 15 respectively.

The method in accordance with the invention for the transport of heat energy from at least one heat source to at least one heat sink takes place by means of a working fluid which includes a mixture of at least one first component having a first boiling point and of a second component having a second boiling point, with the first boiling point being lower than the second boiling point. In a first step, at least some of the first component of the working fluid is vaporized by the supply of heat from the heat source. Subsequently, the vaporized portion of the first component is transported separately from the working fluid depleted by the vaporization with respect to the first component from the heat source to the heat sink by means of a transport means. The temperature of the first component and of the depleted working fluid on the transport from the heat source to the heat sink substantially corresponds to a temperature prevailing in the environment of the transport means.

After the transport, the vaporized first component is then again absorbed by the depleted working fluid, with the heat absorbed on the vaporization being discharged to the heat sink.

This method is in particular suitable for a district heating network.

The heat source can, for example, be a conventional thermal power station which converts heat energy into electrical energy, with the heat energy being able to be provided, for example, by the combustion of fossil fuels or by nuclear processes. Natural heat sources can be geothermal heat or solar radiation.

Instead of a thermal power station, a waste heat generating industrial process can also be considered as the heat source.

Possible heat sinks are, for example, heating systems of private residences or of commercially used premises. The transferred heat can, however, also be used as process heat in industrial enterprises.

The transfer of the heat between the heat source and the heat sink takes place by means of a working fluid which is a mixture of at least two difference substances—components—having different boiling points. If heat from the heat source, that is the waste heat of a power station, for example, is supplied to the working fluid, the component having the lower boiling point starts to vaporize first, with the concentration of the first component in the mixture reducing. A gaseous phase arises, which substantially comprises the first component, and a liquid phase, which is formed by the working fluid depleted with respect to the first component. The first component and the depleted working medium are transported separately from one another from the heat source to the heat sink and are only combined again there, with the first component also being able to be present in liquid form during the transport. On the absorption of the first component by the depleted working fluid, which takes place after the transport, the heat required before the transport for the vaporization of the first component is discharged again and can be made usable to the heating system of a household, for example, via a heat exchanger.

The method for the transport of heat energy is thus based on a thermodynamic circuit having an at least two-component substance mixture as the working fluid which in particular includes the splitting of the working fluid into two part flows having different aggregate phases due to a selective vaporization of at least one component of the working fluid. The heat energy previously brought to vaporization is discharged again on the recombination of the part flows transferred separately from one another. The vaporization and the absorption form part of a reversible process so that the absorbed vaporization heat corresponds to the discharged absorption heat.

To increase the efficiency of the system, the part flows are transferred approximately at ambient temperature so that the thermal gradient between the part flows and ambient is as low as possible. Practically no heat transfer—or only a small heat transfer—takes place from the working fluid to ambient due to the small temperature drop. This unwanted heat transfer represents a considerable problem with conventional methods and can only be reduced to a reasonably acceptable amount by extensive insulation measures.

In other words, the first component and the depleted working fluid are transferred—at least in a large majority of the implementations of the method—at a temperature which is below the temperature level of the heat sink. The heat energy is only released again and supplied to the heat sink on site.

A further advantage of the method in accordance with the invention is that the heat energy absorbed on the vaporization can be stored in that the part flows are stored separately from one another, for example in tanks. The part flows are only recombined as required. The discharge of the heat energy can thus be controlled time-wise.

Advantageous embodiments of the invention are set forth in the dependent claims, in the description and in the drawings.

In accordance with an embodiment of the method in accordance with the invention, the vaporized portion of the first component is transported from the heat source to the heat sink in a gaseous aggregate phase, whereas the working fluid depleted with respect to the first component is transported from the heat source to the heat sink in a liquid aggregate phase.

The separate transport of the part flows can generally take place by truck or other mobile transport means. It is, however, preferred for the working fluid to be transported from the heat source to the heat sink by two separate pipes, with a first pipe being provided for the transport of the first component and a second pipe being provided for the transport of the working fluid depleted with respect to the first component. In this embodiment, it has proven to be expedient to transport the working fluid which was “recycled” again in the heat sink by absorption of the first component back to the heat source through a third pipe. A closed and continuously operable circuit is thereby created.

The pipes can be laid together as a bundle in the earth. The ambient temperatures prevailing there amount to approximately 10° C. The temperature of the part flows transferred through the first and second pipes is therefore preferably in a range around 10° C. With a correspondingly deep laying of the pipes in the earth, this temperature hardly fluctuates over the seasons due to the thermal inertia of the earth.

The vaporization of the first component of the working fluid can take place at a substantially constant temperature, with the pressure of the working fluid being lowered step-wise as the concentration of the first component in the working fluid falls. This stepwise lowering—or a lowering also taking place in stages—of the pressure of the working fluid simplifies the expulsion of the first component from the working fluid and thus contributes to the improvement of the efficiency of the system.

In accordance with a further embodiment of the method in accordance with the invention, the vaporization of the first component of the working fluid takes place at least partly in a first pressure region of the working fluid which is disposed above the pressure of the first component on the transport from the heat source to the heat sink. At least one further part of the vaporization of the first component of the working fluid takes place in a second pressure range of the working fluid which is disposed beneath the pressure of the first component on the transport form the heat source to the heat sink.

In other words, in this embodiment, the pressure of the portion of the first component vaporized in the first pressure range is lowered to a transport pressure. The term “pressure range” should express that the vaporization can take place at one pressure level or at a plurality of different pressure levels above the transport pressure. The same applies analogously to the second pressure range which is disposed beneath the transport pressure. The portion of the first component vaporized at one pressure level or at a plurality of different pressure levels of the second pressure range is raised to the transport pressure level for the transport.

The portion of the first component obtained on the vaporization in the first pressure range can be utilized for the production of mechanical energy, whereas the portion of the first component obtained on the vaporization in the second pressure range is sucked off by at least one compressor. The mechanical energy produced is preferably used directly for the drive of the compressor. Provision can, however, also be made to convert the mechanical energy into electrical energy.

The absorption of the first component by the depleted working fluid at the heat sink side can take place at a substantially constant pressure, with the absorption taking place at temperatures dropping step-wise as the concentration of the first component in the working fluid increases. The absorption can thus take place—like the expulsion of the first component—step-wise or stage-wise.

An ammonia/water mixture has proved to be a suitable working liquid, with the mixing ratio of water to ammonia amounting to approximately 4 to 6 (40% water, 60% ammonia). The mixing ratio relates to the working fluid in the base state prior to the vaporization of a portion of the first component, for example on the way from the heat sink to the heat source.

In other words, the preferred working fluid is a solution of ammonia (NH₃) in water (60% ammonia solution), with the concentration of the solution being able to be adapted to the respectively prevailing demands. Depending on the constraints of the heat transport, for example the temperature level of the heat source and/or of the heat sink, different substance mixtures can be provided.

The method in accordance with the invention allows the transport of more heat energy per volume unit in comparison with the previously used heat carriers. Water is, for example, transferred at a temperature of approximately 80° in conventional district heating networks. When the water is cooled by 50° C. in a heating system, the useful heat quantity therefore amounts to a maximum of 50 kcal. In contrast to this, in the method in accordance with the invention, a heat quantity of approximately 150 kcal per liter is released on the recombination of the ammonia and of the residual solution. The higher “heat density” of the present method therefore makes it possible to make the dimensions of the transport means of the working fluid—for example pipes—correspondingly smaller.

The efficiency of the heat transport method in accordance with the invention also depends on the efficiency of the extraction process—i.e. of the expulsion—of the first component of the working fluid from the working fluid. The concept of the invention therefore furthermore includes an extraction apparatus to increase the efficiency of the extraction of the first component of the working fluid described above. This extraction apparatus includes at least one turbine and at least one compressor, with the turbine and the compressor each being able to have a portion of the first component vaporized by the supply of heat supplied in a gaseous state. The pressure of the portion of the first component supplied to the turbine is higher than the pressure of the portion of the first component supplied to the compressor. The turbine can be driven to make a rotary movement by the portion of the first component supplied to it, whereas the compressor can be driven to increase the pressure of the portion of the first component supplied to the compressor.

The gaseous first component can be supplied to the turbine and/or to the compressor in each case at a plurality of different pressure levels. In this case, the turbine and/or the compressor are in particular multistage, with respective portions of the gaseous first component being able to be supplied to the stages of the turbine and/or of the compressor at a respective stage-specific pressure level. The method described above for the vaporization of the first component can thereby be implemented in a simple and efficient manner.

The efficiency of the system is additionally increased when the turbine and the compressor are directly coupled to one another mechanically, in particular have a common axis of rotation. A mechanical coupling can generally also be provided via a transmission stage arranged between the turbine and the compressor.

A district heating network in accordance with the invention for the transport of heat energy from at least one heat generator to at least one heat consumer by means of the previously described working fluid includes at least one expeller for the separation of a portion of the first component from the working medium, a pipe system and at least one absorber for the absorption of the separated portion of the first component by the working fluid depleted with respect to the first component, with the pipe system in each case having a separate pipe for the transport of the separated portion of the first component and of the working fluid depleted with respect to the first component from the expeller to the absorber. The expeller and the absorber can each be in communication with the heat generator and the heat consumer respectively via a heat exchanger.

The heat generator and the heat consumer can be one or more of the heat sources or heat sinks respectively described above.

To improve the efficiency of the district heating network, an extraction apparatus in accordance with any one of the embodiments described above can be associated with the expeller.

It is preferred for the expeller to be arranged at the heat generator and for the absorber to be arranged at the heat consumer. The expeller is, for example, located in spatial proximity to a power station, whereas the absorber is arranged in a building to be heated.

The invention will be described in the following purely by way of example with reference to advantageous embodiments and to the drawings. There are shown:

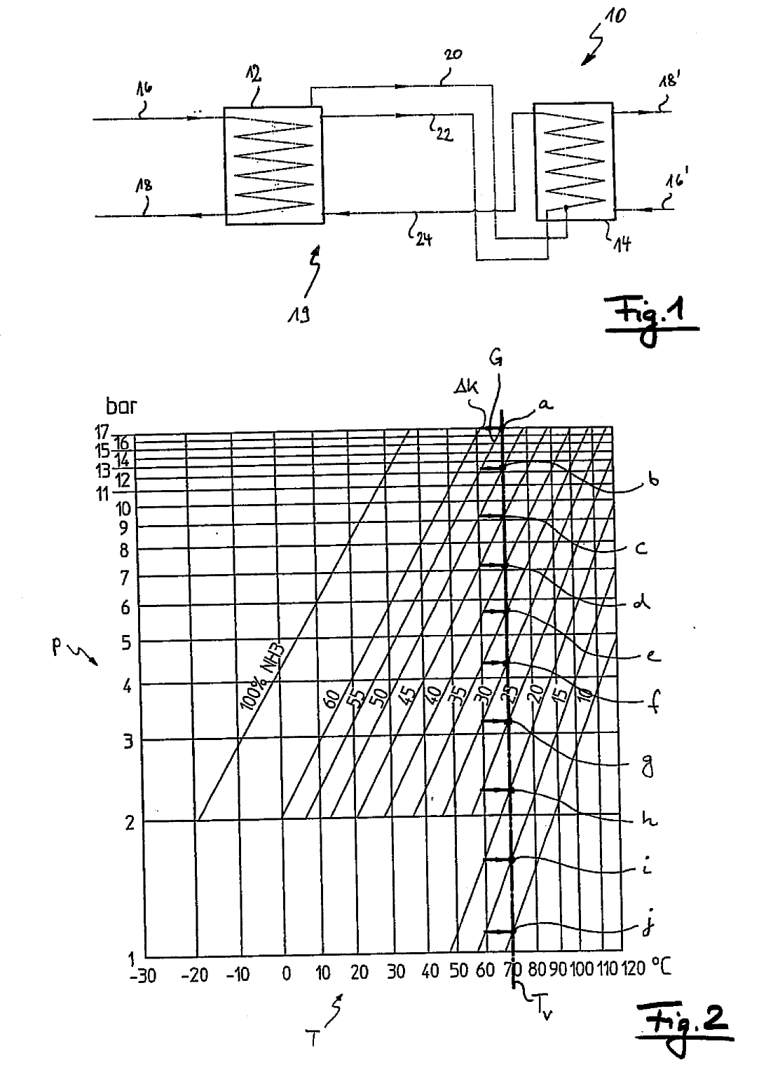

FIG. 1 a schematic representation of an embodiment of a system for the transport of heat energy;

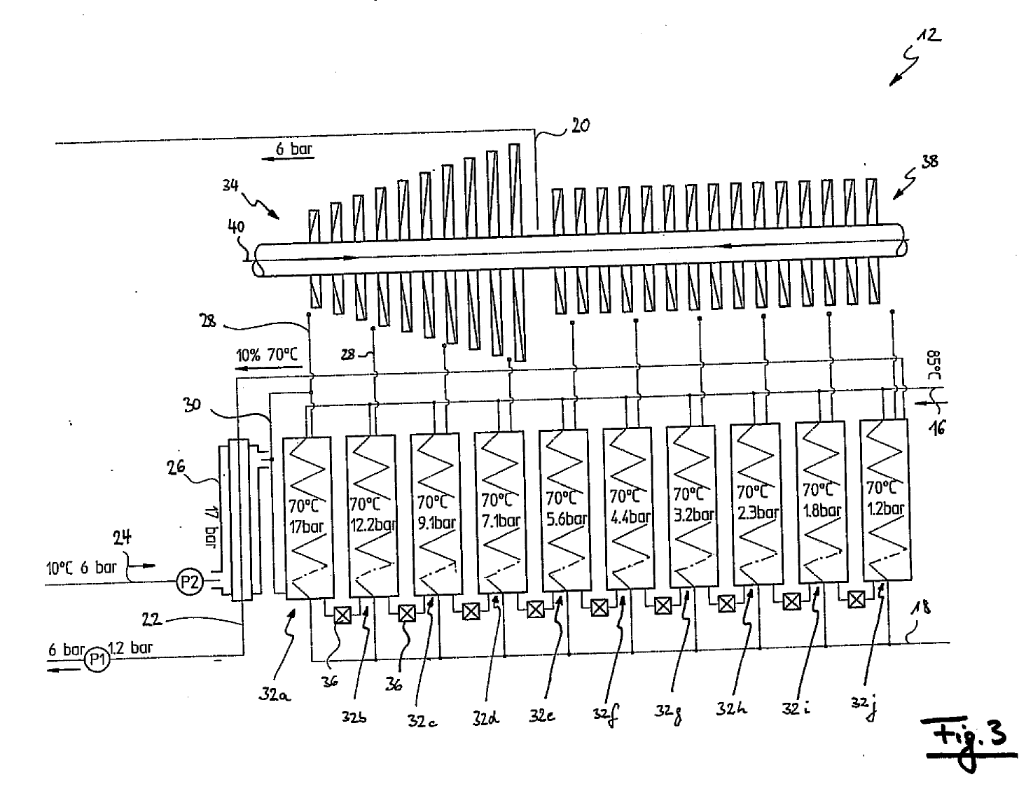

FIG. 2 a pressure/temperature phase diagram for different ammonia/water mixtures with different ammonia concentrations;

FIG. 3 a schematic representation of a system for the separation of ammonia gas from an ammonia/water mixture by vaporization;

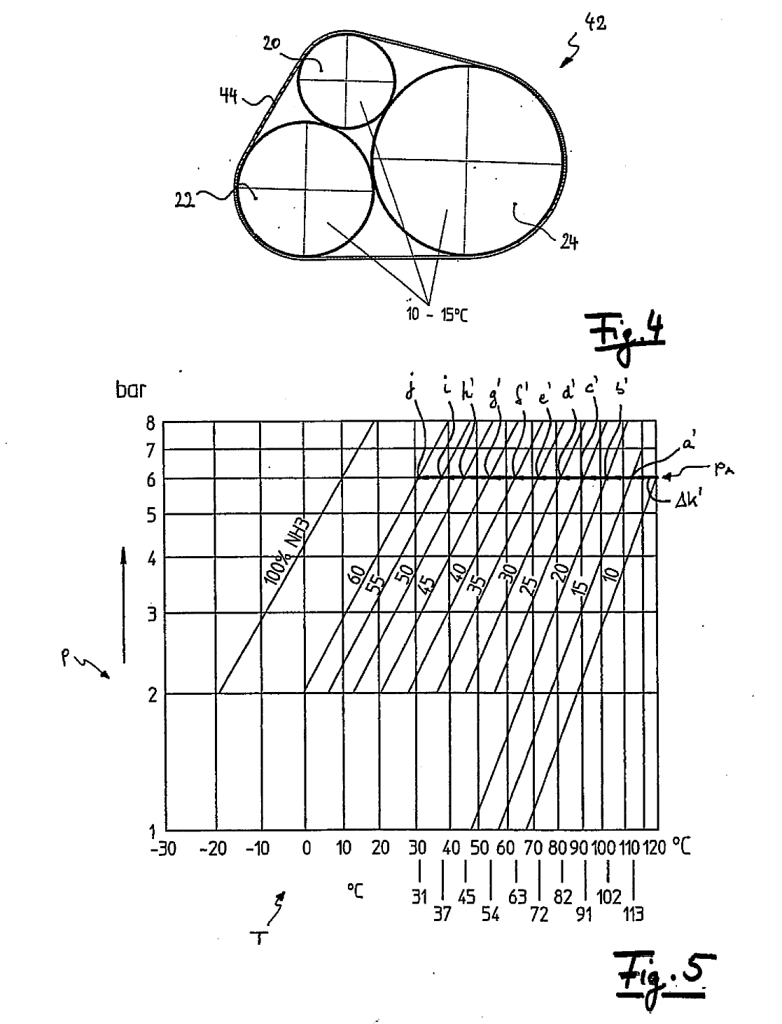

FIG. 4 a schematic cross-section through a pipe system of a district heating network in accordance with the invention;

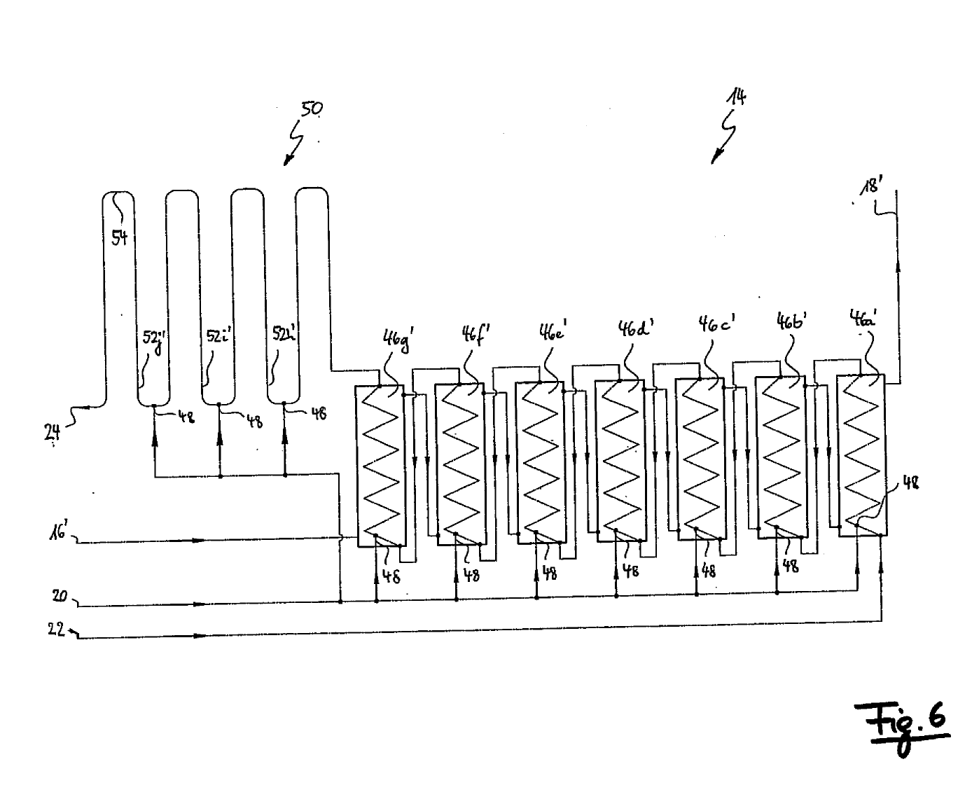

FIG. 5 a pressure/temperature phase diagram to illustrate the absorption of the ammonia gas by a depleted ammonia/water mixture;

FIG. 6 a system for the absorption of the ammonia gas by the depleted ammonia/water mixture.

FIG. 1 shows a heat transport system 10 including an expeller 12 and an absorber 14. The absorber 12 is in communication with a heat source (not shown) via an infeed 16 and an outfeed 18. In other words, a hot working fluid, for example hot water or steam, is supplied to the expeller 12 and exits the expeller 12 again through the outfeed 18. In an analogous manner, the absorber 14 is in communication with a heat sink (not shown) via an infeed 16′ and an outfeed 18′. The expeller 12 and the absorber 14 are likewise in communication with one another via pipes 20, 22, 24, whereby a heat transport circuit 19 is formed in which a working fluid can circulate. In the embodiment of the heat transport system 10 shown, the working fluid is a 60% mixture of ammonia and water.

In the expeller 12, heat is supplied to the working fluid—in a similar manner to a conventional heat exchanger—and is removed as waste heat from the working fluid of the heat source. The waste heat of the heat source utilized by the present method in accordance with the invention has a relatively low temperature (working fluid temperature) so that it is no longer suitable for power generation. Conventionally, this waste heat is led off unused via cooling systems. The waste heat can, however, advantageously be made useful by the ammonia/water mixture in the heat transport circuit 19.

While the water has not yet reached its boiling point at the usual waste heat temperatures, the ammonia begins to vaporize. The working fluid therefore splits into an ammonia gaseous phase and into a liquid phase of the working fluid which is increasingly depleted with respect to the ammonia and is also called a residual solution. In other words, the working fluid is separated into two part flows with different aggregate phases while vaporization heat is being supplied.

The two part flows are subsequently supplied to the absorber 14 separately from one another. For this purpose, the heat transport circuit 19 has an ammonia gas line 20 and a residual solution line 22 for the depleted working fluid.

In the absorber 14, ammonia gas is again supplied to the depleted working fluid—the residual solution. In a reversal of the endogenic vaporization process, the absorption of the ammonia gas by the residual solution is an exogenic process in which the heat used in the vaporization is released again. The released heat is output in the absorber 14 to a working fluid of the heat sink, for example the water of a heat circuit, and is subsequently outlet via the outfeed 18′.

The starting composition of the working fluid is reestablished by the absorption of the gaseous ammonia by the residual solution. The working fluid is subsequently guided through a return line 24 from the absorber 14 to the expeller 12 where the previously described thermodynamic process starts again.

As initially described, the greatest heat losses in conventional district heating networks occur during the transport of the hot working fluid between the heat source and the heat sink. In the present system, in contrast, the heat is “buffered” by the splitting of the working fluid into different aggregate phases and is only released by recombination of the part flows on site. No hot working fluid therefore has to be transferred to transport heat energy. The temperature of the part flows, i.e. the temperature of the ammonia gas and of the residual solution in the lines 20, 22 approximately corresponds to the temperature of their environment and is therefore usually below the temperature level of the working fluid of the heat sink. If the lines 20, 22, 22 are, for example, pipe systems which are laid in the earth, the transfer temperature amounts approximately to 10° C., with the transfer temperature also being able to deviate from this value by +/−50%, for example. Due to the low temperature gradient, or the completely lacking temperature gradient, between the transferred part flows and the earth surrounding the pipe, the additional heat losses are very low.

Both the gaseous and the liquid part flows admittedly have increased temperatures after leaving the expeller 12. This heat can, however, be removed from the part flows in a suitable manner before the transport to the absorber 14, for example to heat the working fluid in the return line 24 before the entry of the working fluid into the expeller 12 in order to further improve the efficiency of the system.

The expulsion process of the ammonia will be described in the following with reference to the phase diagram of FIG. 2. FIG. 2 shows pressure/temperature phase diagrams (p-T diagrams) for ammonia/water mixtures having different ammonia concentrations, with the temperature T being drawn on the abscissa and the pressure p being drawn on the ordinate. The lines extending obliquely to the axes of the coordinate system represent the balance states between the gaseous phase and the liquid phase of ammonia/water mixtures with different ammonia concentrations. That is, gaseous ammonia starts to leave the solution with p-T conditions which are to the right of the respective line. The numerals associated with the oblique lines show the corresponding concentration of the ammonia in the solution.

If, for example, at the start of the thermodynamic process described above with reference to FIG. 1—i.e. on the entry of the mixture into the expeller 12—a 60% ammonia/water mixture is present at a pressure of 17 bar and a vaporization temperature T_{V} of 70° C. (state a), then ammonia gas starts to vaporize. In other words, the ammonia is “boiled out” or “expelled” from the solution by the constant supply of heat. In this connection, the concentration of the dissolved ammonia falls until the solution has an ammonia concentration of 55%. The concentration change ΔK is illustrated by the thick horizontal arrow. The working fluid is therefore depleted. As can be seen from FIG. 2, no more ammonia can degas at 17 bar and 70° C. At this concentration and at these pressure and temperature relationships (p-T relationships), the solution is in balance, which is symbolized by the oblique line G marked with the numeral 55 and representing the balance state of a 55% ammonia solution as a function of the pressure and of the temperature.

To continue the expulsion of the ammonia gas, the pressure of the now 55% ammonia solution is reduced to 12.2 bar, with the temperature being maintained by the constant supply of heat of the heat source constantly at the vaporization temperature T_{V} of approximately 70° C. (state b). With these p-T relationships, ammonia gas is again expelled from the solution until an ammonia concentration of 50% is reached.

If in the p-T relationships prevailing in the state b, an ammonia concentration of 50% is reached, the pressure is lowered—with a temperature T_{V} remaining the same—to 9.1 bar (state c) so that ammonia gas can continue to be expelled from the solution.

As indicated in FIG. 2, the pressure lowering takes place at a constant vaporization temperature T_{V} in a plurality of steps. The further steps include pressure levels of 7.1 bar (state d), 5.6 bar (state e), 4.4 bar (state f), 3.2 bar (stage g), 2.3 bar (state h), 1.8 bar (state i) and 1.2 bar (state j). After the last pressure lowering step, the residual solution has an ammonia concentration of only 10%. This residual solution and the expelled gaseous ammonia are then transported to the absorber as already described above.

The pressure lowering preferably does not take place in a singe expeller stage in steps sequential in time, but is rather carried out continuously in a plurality of stages by means of a cascade-like arrangement of expeller units, as will be described in the following with reference to FIG. 3.

FIG. 3 shows an expeller 12 to which the 60% ammonia/water mixture is supplied through the return line 24 at 10° C. and 6 bar. The pressure of the working fluid is increased to 17 bar by a pump P2. Subsequently, the working fluid enters into a heat exchanger 26 where it is heated by the depleted solution in the residual solution line 22 in the counterflow process. Some of the ammonia is possibly already expelled in the heat exchanger 26 and is supplied directly to a supply line 28 via a bridging line 30.

The main portion of the preheated working fluid is led to a first expeller stage 32a. The expeller stage 32a is supplied through the infeed 16 with steam coming at a temperature of 85° C. from a low pressure steam turbine (not shown). The steam condenses in the expeller stage 32a while emitting heat to form liquid water which is again supplied to the power station via the outfeed 18. In the first expeller stage 32a, the ammonia/water solution has a temperature T_{V} of 70° C. and 17 bar (state a). Due to the cooling of the steam, heat is emitted to the solution which results in the vaporization of some of the dissolved ammonia which is supplied to a turbine 34 via the supply line 28. The ammonia gas supplied to the turbine 34 has a pressure of 17 bar.

If the concentration of the ammonia in the ammonia/water solution has been reduced to 55%, the liquid pressure is reduced by a pressure reducing valve 36 to a pressure of 12.2 bar and the depleted working fluid is led into the next expeller stage 32b where, in an analogous manner, heat is removed from the steam of the power station for the vaporization of the ammonia. The ammonia gas is supplied to the turbine 34 at a pressure of 12.2 bar.

A separate expeller stage 32a to 32j is respectively associated with the states a to j of FIG. 2 and work at the corresponding pressure levels. The temperature adopted in the expeller stages 32a to 32j is approximately the same and amounts to 70° C. As already stated above, the respective pressure level prevailing in the expeller stages drops in this cascade arrangement of the expeller stages 32a to 32j. Ammonia gas is therefore supplied to the turbine 34 via respectively separate supply lines 28 at different pressure levels.

The turbine 34 is therefore preferably a multistage turbine. With such a turbine 34, the ammonia gas can be injected into the respective suitable turbine stage at the different pressure levels. To achieve a high efficiency, the expeller stages 32a to 32d associated with the turbine and the stages of the turbine 34 are coordinated with one another.

The turbine 34 thus receives ammonia gas at different pressure levels which are all above a transport pressure of approximately 6 bar. The transport pressure serves for the transfer of the ammonia gas from the expeller 12 to the absorber 14. The turbine 34 is driven to make a rotary movement due to the difference between the ammonia gas pressure of the expeller stages 32a to 32d and the transport pressure. The mechanical energy arising in this connection can either be converted via a generator (not shown) into electrical energy or can be supplied directly or indirectly to a compressor 38 which raises the ammonia gas of the expeller stages 32e to 32j associated with the states e to j to the transport pressure level of 6 bar. Analogously to the turbine 34, the compressor 38 is also multistage so that ammonia gas can be supplied to it at different pressure levels.

As shown in FIG. 3, the turbine 34 and the compressor 38 form a unit with a common axis of rotation 40. In other words, the ammonia gas expelled at high pressures drives the turbine 34 to move the ammonia gas expelled at low pressures to the transport pressure level of approximately 6 bar by the compressor 38. A generator (not shown) can possibly additionally be connected to the axis of rotation 40 to convert excess mechanical energy into power. The turbine/compressor combination of the turbine 34 and of the compressor 38 supports the separation of the ammonia gas from the solution and thus increases the efficiency of the thermodynamic circuit.

The expelled ammonia gas and the residual solution depleted with respect to the ammonia are transported to the absorber 14 via the ammonia gas line 20 or the residual solution line 22. The residual solution line 22 is in communication with the last absorber stage 32j of the absorber stage cascade and has the initially described heat exchanger 26 in its extent for the heating of the working fluid flowing into the expeller 12. It must be noted that the residual solution—that is the depleted working fluid—is thereby cooled down to a much lower temperature level. The transport pressure required for the transfer of the residual solution (10% ammonia/water solution) is provided by a pump P1.

FIG. 4 shows a cross-section through the pipe system 42 connecting the expeller 12 and the absorber 14. The pipe system 42 includes the ammonia gas line 20, the residual solution line 22 and the return line 24. The lines 20, 22, 24 are surrounded by a common insulation 44 which can, however, be made simply since the actual heat transport does not take place through the transfer of a hot working fluid, but rather through the phase separation of the multicomponent working fluid with a subsequent recombination of the phases by absorption. The insulation 44 additionally represents protection against mechanical influences and corrosion. Under certain circumstances, the insulation 44 can also be completely dispensed with out the efficiency of the method being substantially impaired.

Due to the heat transfer by means of separate components of the ammonia/water mixture and the therefore subordinate importance of the pipe system insulation, the temperature of the transferred fluid flows approximately corresponds to the ambient temperature of the earth surrounding the pipe system 42; in the example here approximately 10° C. to 15° C. The pressure and temperature ratios in the ammonia gas line 20 only have to be adapted such that condensation of the ammonia gas is prevented.

FIG. 5 shows a section of the phase diagram of FIG. 2, with the curve of the absorption process of the ammonia gas therein being shown by the depleted ammonia/water solution.

In contrast to the expulsion, the absorption takes place at a constant absorption pressure p_{A}, which substantially corresponds to the transport pressure. In the embodiment shown, the absorber 14 receives both the ammonia gas and the depleted residual solution at a pressure of approximately 6 bar. In a first step, the 10% residual solution delivered from the expeller 12 is enriched by the absorption of ammonia gas and reaches an ammonia concentration of 15%. In this absorption step, the maximum achievable temperature in the water/ammonia solution amounts to 113° C., as can be seen from the phase diagram (state a′). The temperature of the residual solution is therefore raised by the absorption of the ammonia gas to a maximum of 113° C. and the residual solution is simultaneously enriched. The concentration change ΔK′ is marked by a horizontal arrow.

The heating of the residual solution is emitted to the heat sink, for example to a heating water circuit of a household. The residual solution enriched by 5% again receives ammonia gas in a next step and is thereby heated to up to 102° C. (state b′), with the ammonia concentration in the residual solution increasing to 20%. This procedure is repeated (states c′ to j′) until the starting mixture (60% ammonia/water solution) is reached and the heat amount absorbed in the expeller 12 for the vaporization of the ammonia gas is substantially emitted again.

FIG. 6 shows schematically how an absorber 14 can be designed in a consumer. The absorber 14 includes seven absorber heat exchanger stages 46a′ to 46g′, with the letters corresponding to the corresponding pressure and temperature states a′ to g′ of FIG. 5. Each of the absorber heat exchanger stages 46a′ to 46g is supplied with ammonia gas from the ammonia gas line 20. The residual solution line 22 is in communication with the absorber heat exchanger stage 46a′. Ammonia gas is there supplied to the 10% residual solution through a Venturi nozzle 48. Heat is released by the residual solution by the absorption of the gas and is emitted to the working fluid of the heat sink which is output through the outfeed 18′. The residual solution enriched by 5% is subsequently supplied to the absorber heat exchanger stage 46b′, where the procedure described above is repeated in an analogous manner.

Another suitable apparatus can be provided instead of the Venturi nozzle 48 for the introduction of the ammonia gas into the residual solution.

The working fluid of the heat sink is supplied to the absorber heat exchanger cascade for the first time at the absorber heat exchanger stage 46g′. The working fluid of the heat sink—that is of the consumer—is thereby raised stepwise from 54° C. (state g′) to a maximum of 113° C. (state a′), whereas in return the ammonia concentration in the residual solution increases from 10% (state a′) to 45% (state g′).

The solution flowing out of the absorber heat exchanger stage 46g′ is not suitable to preheat the heating water in an efficient manner in a further absorber stage since temperatures can only be reached by further concentration changes which are slightly higher than the temperature of the heating water flowing into the absorber cascade. At low temperature differences, the efficiency of the heat exchange is low. The absorber 14 therefore has a floor heating component 50 which utilizes the residual heating potential of the residual solution in three stages 52h′, 52i′, 52j′ by the supply of ammonia gas. The residual solution can be heated to temperatures of 45° C. (state h′) and 37° C. (state i′) and 31° C. (state j′) respectively by the three enrichment stages of 45% to 50% and of 50% to 55% and of 55% to 60% respectively. These temperatures are very suitable for floor heating systems with a suitable conception of the heating system. The heat of the residual solution is emitted directly to the building in the floor heating component 50.

The solution again having the starting mixture ratio of 60% after the enrichment stage 52j′ can emit its residual heat to the building in further heating loops 54 (only one shown in FIG. 6) before it is again supplied to the expeller 12 via the return line 24.

It can easily be seen from the above statements that the said values for pressure, temperature and concentration only have an exemplary character. The p-T states of the individual stages can be freely selected in accordance with the demands. In addition, other working fluids can be provided which are suitable for the demanded temperature ranges.

It is in particular possible that—deviating from the previously described exemplary embodiment of the method—the vaporization temperature T_{V} is less than 70° C. At a vaporization temperature T_{V} of approximately 60° C., the power output by the turbine 34 corresponds approximately to the power taken up by the compressor 38.

At lower vaporization temperatures T_{V}, the other relevant method parameters should also be adapted to optimize the method in accordance with the invention. At a vaporization temperature T_{V} of 60° C., it is advantageous, for example, if the ammonia concentration is only lowered to 20%. In other words, in this case, the last two depletion steps i and j (see FIG. 2) are omitted in the vaporization of the ammonia. The corresponding expeller stages 32i and 32j can consequently be dispensed with. The absorber heat exchanger stages 46a′ and 46b′ are then also dispensed with at the heat sink side.

If no corresponding raising of the minimal concentration of the ammonia in the residual concentration is carried out at even lower vaporization temperatures T_{V}, the compressor 38 must additionally be driven by a further aggregate since the turbine power is no longer sufficient for the operation of the compressor 38.

It must furthermore be noted that the proposed extraction apparatus, which is based on a turbine/compressor combination, is also suitable for a plurality of other areas of application in which an efficient extraction of a gas component from at least one carrier liquid is of importance.

### REFERENCE NUMERAL LIST

10 heat transport system
12 expeller
14 absorber
16, 16′ infeed
18, 18′ outfeed
19 heat transport circuit
20 ammonia gas line
22 residual solution line
24 return line
a-j, a′-j′ p-T state
26 heat exchanger
28 turbine supply line
30 bridging line
32a-32j expeller stage
34 turbine
36 pressure reducing valve
38 compressor
40 axis of rotation
42 pipe system
44 insulation
46a′-46g′ absorber heat exchanger stage
48 Venturi nozzle
50 floor heating component
52h′-52j′ enrichment stage
p_{A} absorption pressure
T_{V} vaporization temperature
ΔK, ΔK′ concentration change
G balance line

1. A method for the transport of heat energy from at least one heat source to at least one heat sink, in particular for a district heating network, by means of a working fluid which includes a mixture of at least one first component having a first boiling point and of a second component having a second boiling point, with the first boiling point being lower than the second boiling point, in the steps:
at least partial vaporization of the first component of the working fluid by the supply of heat from the heat source;
transport of the vaporized portion of the first component separately from the working fluid depleted by the vaporization with respect to the first component from the heat source to the heat sink by means of a transport means;
absorption of the vaporized first component by the depleted working fluid while emitting the heat absorbed in the vaporization to the heat sink,
wherein the temperature of the first component and of the depleted working fluid on the transport from the heat source to the heat sink substantially corresponds to a temperature prevailing in the environment of the transport means.

2. A method for the transport of heat energy in accordance with claim 1, characterized in that the vaporized portion of the first component is transported in a gaseous aggregate phase from the heat source to the heat sink; and in that the working fluid depleted with respect to the first component is transported in a liquid aggregate phase from the heat source to the heat sink.

3. A method for the transport of heat energy in accordance with claim 1, characterized in that the working fluid is transported through two separate pipes (20, 22) from the heat source to the heat sink, with a first pipe (20) being provided for the transport of the first component and a second pipe (22) being provided for the transport of the working fluid depleted with respect to the first component; and in that the working fluid is transported through a third pipe (24) from the heat sink to the heat source.

4. A method for the transport of heat energy in accordance with claim 1, characterized in that the vaporization of the first component of the working fluid takes place at a substantially constant temperature (T_{V}), with the pressure of the working fluid being lowered step-wise as the concentration (ΔK) of the first component in the working fluid falls.

5. A method for the transport of heat energy in accordance with claim 1, characterized in that the vaporization of the first component of the working fluid takes place at least partly in a first pressure range of the working fluid which is above the pressure of the first component on the transport from the heat source to the heat sink; and in that the vaporization of the first component of the working fluid takes place at least partly in a second pressure range of the working fluid which is below the pressure of the first component on the transport from the heat source to the heat sink.

6. A method for the transport of heat energy in accordance with claim 5, characterized in that the portion of the first component obtained on the vaporization in the first pressure range is used for the generation of mechanical energy.

7. A method for the transport of heat energy in accordance with claim 5, characterized in that the portion of the first component obtained on the vaporization in the second pressure range is sucked off by at least one compressor.

8. A method for the transport of heat energy in accordance with claim 6, characterized in that the mechanical energy generated is used directly to drive the compressor.

9. A method for the transport of heat energy in accordance with claim 1, characterized in that the absorption of the first component by the working fluid takes place at a substantially constant pressure (p_{A}), with the absorption taking place at temperatures dropping step-wise as the concentration (ΔK) of the first component in the working fluid increases.

10. A method for the transport of heat energy in accordance with claim 1, characterized in that the first component of the working fluid is water and the second component of the working fluid is ammonia, with the mixture ratio of water to ammonia amounting approximately to 4 to 6.

11. An extraction apparatus to increase the efficiency of the extraction of a component of a working fluid comprising a mixture of at least one first component having a first boiling point and of a second component having a second boiling point, with the first boiling point being lower than the second boiling point, said extraction apparatus comprising at least one turbine (34) and at least one compressor (38), with a respective portion of the first component vaporized by the supply of heat being able to be supplied to the turbine (34) and the compressor (38) in each case in a gaseous state, with the pressure of the portion of the first component supplied to the turbine (34) being higher than the pressure of the portion of the first component supplied to the compressor (38) and with the turbine (34) being able to be driven to make a rotary movement by the portion of the first component supplied to it to increase the pressure of the portion of the first component supplied to the compressor (38).

12. An extraction apparatus in accordance with claim 11, characterized in that the gaseous first component can in each case be supplied to the turbine (34) and/or to the compressor (38) at a plurality of different pressure levels.

13. An extraction apparatus in accordance with claim 12, characterized in that the turbine (34) and/or the compressor (38) are multistage, with respective portions of the gaseous first component being able to be supplied to the stages of the turbine (34) and/or of the compressor (38) at a respective stage-specific pressure level.

14. An extraction apparatus in accordance with claim 11, characterized in that the turbine (34) and the compressor (38) are directly coupled to one another mechanically, in particular have a common axis of rotation (40).

15. A district heating network for the transport of heat energy from at least one heat generator to at least one heat consumer by means of a working fluid comprising a mixture of at least one first component having a first boiling point and of a second component having a second boiling point, with the first boiling point being lower than the second boiling point, wherein the district heating network comprises at least one expeller (12) for the separation of some of the first component from the working fluid, a pipe system (42) and at least one absorber (14) for the absorption of the separated portion of the first component by the working fluid depleted with respect to the first component, wherein the pipe system (42) in each case has a separate pipe (20, 22) for the transport of the separated portion of the first component and of the working fluid depleted with respect to the first component from the expeller (12) to the absorber (14).

16. A district heating network for the transport of heat energy from at least one heat generator to at least one heat consumer by means of a working fluid comprising a mixture of at least one first component having a first boiling point and of a second component having a second boiling point, with the first boiling point being lower than the second boiling point, wherein the district heating network comprises at least one expeller (12) for the separation of some of the first component from the working fluid, a pipe system (42) and at least one absorber (14) for the absorption of the separated portion of the first component by the working fluid depleted with respect to the first component, wherein the pipe system (42) in each case has a separate pipe (20, 22) for the transport of the separated portion of the first component and of the working fluid depleted with respect to the first component from the expeller (12) to the absorber (14), characterized in that an extraction apparatus is associated with the expeller (12), said extraction apparatus comprising at least one turbine (34) and at least one compressor (38), with a respective portion of the first component vaporized by the supply of heat being able to be supplied to the turbine (34) and the compressor (38) in each case in a gaseous state, with the pressure of the portion of the first component supplied to the turbine (34) being higher than the pressure of the portion of the first component supplied to the compressor (38) and with the turbine (34) being able to be driven to make a rotary movement by the portion of the first component supplied to it to increase the pressure of the portion of the first component supplied to the compressor (38).

17. A district heating network in accordance with claim 15, characterized in that the expeller (12) is arranged at the heat generator and the absorber (14) is arranged at the heat consumer.
